(19) United States
(12) Patent Application Publication
(10) Pub. No.: US 2003/0183046 A1
(43) Pub. Date: Oct. 2, 2003

(54) Servicing socket for branch pipe connecting valves

(76) Inventor: Randy Reed Becker, Highland, CA (US)

Correspondence Address: Randy R. Becker, 7324 Westwood Lane, Highland, CA, 92346, US

(21) Appl. No.: 10/099,341

(22) Filed: Mar. 16, 2002

(51) Int. Cl. B25B 13/04

(52) U.S. Cl. 81/120

(57) ABSTRACT

A tool that can be used even in confined quarters with fluid distribution system branch pipe connecting valves, such as corporation valve stops and ball valves, while giving the user an indication of the location of the connecting valve turn key in relation to the connected to distribution pipe, thus helping to eliminate the need for excavating wider trenches. The tool has a top connecting element (10) with a means for attaching (20) to a torque force transfer tool, such as a ratchet wrench, and which through the encompassing effect of its sides (30N, 30E, 30S, and 30W, or alternatively 30C) and through its torque force transfer contact surfaces (30E and 30W or alternatively 41E, 41W, 70, 75L 75R, and 80) provides more protection and better effective distribution of torque force to the body of such connecting valves and enables easier installation.

### CROSS REFERENCE TO RELATED APPLICATIONS

None.

### STATEMENT REGARDING FEDERAL RESEARCH AND DEVELOPMENT

Not applicable.

### BACKGROUND OF INVENTION

1. Field of Invention

This invention relates to tools, in particular to tools that enable the manipulation of valve bodies, specifically a tool for facilitating the installation, tightening, loosening, and removal of apparatuses that connect customer service branch pipes to main distribution pipes; typically these connecting apparatuses contain valves and hence are known as corporation stop valves, corporation stops, service tees, elbows, straight transition fittings, and ball valves.

2. Discussion of Prior Art

Many fluid distribution systems include water mains and gas mains with customer service lines connected to the mains for supplying individual customers. The customer service lines are also known as branch pipes or branch lines. Most of these mains and branch pipes are buried several feet in the ground.

Fittings for connecting branch pipes to the mains usually incorporate a valve therein, either a corporation stop valve or a ball valve, depending on the specifications, collectively referred to as connecting valves. Corporation stop valves may also be called corporation stops, service tees, elbows or straight transition fittings. Connecting valves have turn keys which enable the connecting valve to be opened or closed and thereby respectively allowing or disallowing the flow of fluid.

Typically these connecting valves are threaded to connect to the appropriate threads of a main pipe. As a result, almost invariably the connecting valves to the branch pipes are also buried several feet underground. When the mains, the branch pipes, and the connecting valves are installed, they are all installed in relatively narrow trenches. The trenches are typically narrow because there is greater expenditure of time and money in excavating (and in some instances shoring up) wider trenches and frequently there is greater risk of damaging other lines in the area and/ or of disruption to traffic flows. Further, wider trenches increase the possibility of third party pedestrians injuring themselves. As a result of the narrow trenches, the installation of the connecting valves and branch pipes off of the main pipe is done in very confined quarters. Further despite the frequently encountered confined quarters, installation specifications frequently require that the turn key on the connecting valve be located at a particular place in relation to the main, for example at twelve o'clock, three o'clock or six o'clock.

The confined quarters have created conflicts between the manufacturers of the connecting valves and the employees of the contractors who install the connecting valves. Manufacturers have insisted that the installers use only flat wrenches when installing the connecting valves. However the problem with using flat wrenches lies in the fact that to properly use them and to achieve the necessary amount of torque, a wide space must be available. This requirement does not meet the field conditions in most instances.

The employees of many installation contractors have resorted to using pipe wrenches to install the connecting valves. However pipe wrenches frequently cause distortion of the corporation stop valve body, which eventually leads to leakage. The use of a pipe wrench will void the manufacturer's warranty.

The problem inherent in the conflict has not been resolved to date because manufacturers have relied upon the voiding of their warranty to escape liability and the installers have relied upon the fact that resulting leakage frequently doesn't show itself for several years and that artful use of the pipe wrench may avoid detection by the manufacturer. Significant amounts of time and money are spent determining whether pipe wrench distortion has caused a leakage and determining who bears the cost of the leakage—the municipality, the installer, or the manufacturer. Each leakage repair requires significant expenditure of funds to fix and entails locating a leak, digging the surrounding ground up, and replacing the non-working part. And in the replacement of the part, the cycle repeats itself as the hole or trench dug is invariably even more narrow than the original trench.

The inventor is unaware of any socket, let alone any tool, designed specifically for the installation, tightening, loosening, and removal of connecting valves.

### SUMMARY

In accordance with the present invention a servicing socket for branch pipe connecting valves comprises an enclosure with a top connecting piece that connects to a torque force transfer tool, for example a ratchet wrench, and slips over the main body of a connecting valve thereby transferring the torque force from the user to the connecting valve and thus enabling the user to expeditiously install and tighten, and alternatively to expeditiously loosen and remove, the connecting valve in close quarters without damaging the connecting valve. The preferred embodiment of the invention includes a means to quickly ascertain the location of the turn key for the connecting valve in relation to the distribution pipe being connected to, for example at twelve o'clock, three o'clock or six o'clock.

### OBJECTS AND ADVANTAGES

Accordingly, several objects and advantages of the servicing socket for branch pipe connecting valves are:

(a) to provide a tool that can be used in installing, tightening, loosening and removing connecting valves even in confined quarters;

(b) to provide a tool that can be used in installing, tightening, loosening and removing connecting valves more easily;

(c) to provide a tool that provides more protection for connecting valves during the installation, tightening, loosening, and removal of connecting valves;

(d) to provide a tool that during installation, tightening, loosening, and removal does not damage connecting valves when properly used;

(e) to provide a tool that during installation, tightening, loosening, and removal more effectively distributes torque force to connecting valves;

(f) to provide a tool that helps eliminate the need to excavate wider trenches to enable the installation, tightening, loosening, and removal of connecting valves;

(g) to provide a tool that does not void manufacturer's warranties with regard to connecting valves and is an alternative tool to a flat wrench; and

(h) to provide a tool that during installation, tightening, loosening, and removal indicates where the connecting valve's turn key is located in relation to the distribution pipe being connected to, for example at twelve o'clock, three o'clock or six o'clock.

Further objects, advantages and novel features of the servicing socket for branch pipe connecting valves will become apparent to those skilled in the art and others from a consideration of the specification, drawings and ensuing descriptions and further objects, advantages and novel features may be learned by those skilled in the art and others from practical use of (practice using) the servicing socket for branch pipe connecting valves.

### BRIEF DESCRIPTION OF DRAWINGS

The servicing socket for branch pipe connecting valves can be better understood with reference to the appended drawing sheets. Please note that in the drawings, closely related figures have the same number but different alphabetic suffixes.

FIG. 1 is a perspective (isometric) view of the preferred embodiment: a basic “square” embodiment of the servicing socket for branch pipe connecting valves.

FIG. 2 is a plan view of the preferred embodiment: a basic “square” embodiment of the servicing socket.

FIG. 3 is a perspective (isometric) view of an alternative “square” embodiment of the servicing socket that includes guideplates.

FIG. 4 is a plan view of a basic “square” embodiment of an alternative “square” embodiment of the servicing socket that includes guideplates.

FIG. 5 is a perspective (isometric) view of an alternate embodiment of the basic “square” version of the servicing socket for use with a connecting valve insert attachment.

FIG. 6 is a plan view of an alternate embodiment of the basic “square” version of the servicing socket for use with a connecting valve insert attachment.

FIG. 7 is a perspective (isometric) view of a basic “round” embodiment of the servicing socket, machined to fit the connecting valve with a gripping slot.

FIG. 8 is a plan view of a basic “round” embodiment of the servicing socket, machined to fit the connecting valve with a gripping slot

FIG. 9 is a perspective (isometric) view of a basic “round” embodiment of the servicing socket with machined valve contact spots.

FIG. 10 is a plan view of the connecting valve insert attachment that is used with FIGS. 5 and 6.

FIG. 11 is an isometric view of the connecting valve insert attachment inside the socket cavity.

FIG. 12 is an isometric view of a “square” embodiment of the servicing socket showing the attachment means as a post extending from the top connecting piece.

### REFERENCE NUMERALS IN DRAWINGS

10 Top connecting element

30N Section of sidewall containing turn key location device

30E Section of sidewall containing torque transfer contact surface

30S Section of sidewall counterfacing sidewall 30N

30W Section of sidewall containing counterfacing torque transfer contact surface

41E Guideplate on sidewall 31E

50N Turn key location device

75L Left hand machined valve contact spot

80 Connecting valve insert attachment

20 Attachment means

30C Cylindrical Sidewall

31E Section of sidewall containing guideplate 41E

31S Section of sidewall containing slot for corporation stop packing nut

31W Section of sidewall containing guideplate 41W

41W Guideplate on sidewall 31W

50S Slot for corporation stop packing nut

70 Gripping Slot

75R Right hand machined valve contact spot

90 Cavity

### DETAILED DESCRIPTION

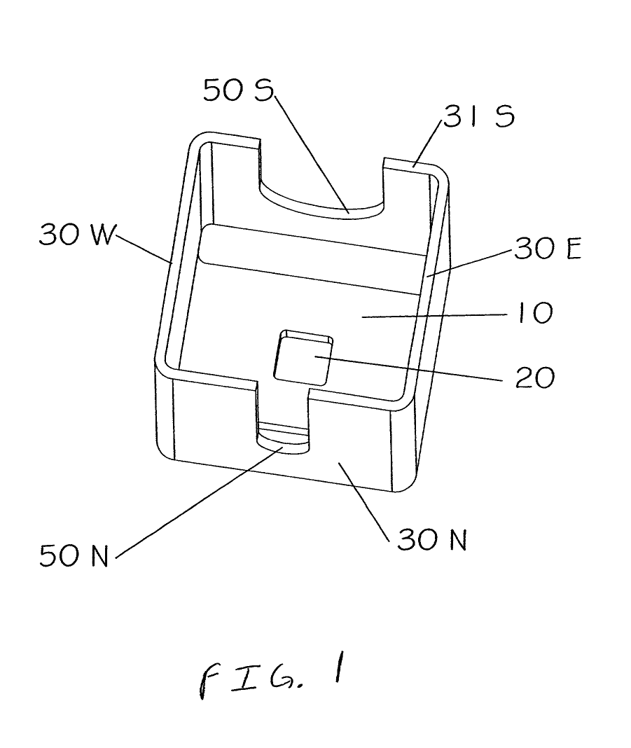

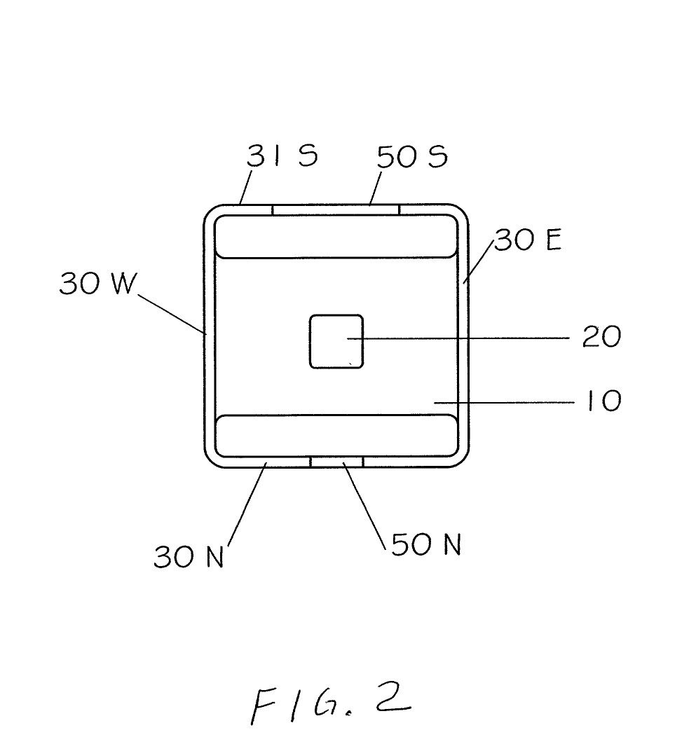

The preferred embodiment of a servicing socket for branch pipe connecting valves in accordance with the present invention is illustrated in FIG. 1 (isometric view) and FIG. 2 (plan view). Both FIG. 1 and FIG. 2 show the servicing socket with the bottom facing up. The servicing socket depicted in FIGS. 1 and 2 comprises a top connecting element 10. To enable the user to turn the servicing socket, an attachment means 20 is provided in top connecting element 10 for attaching a not shown tool, such as a ratchet wrench.

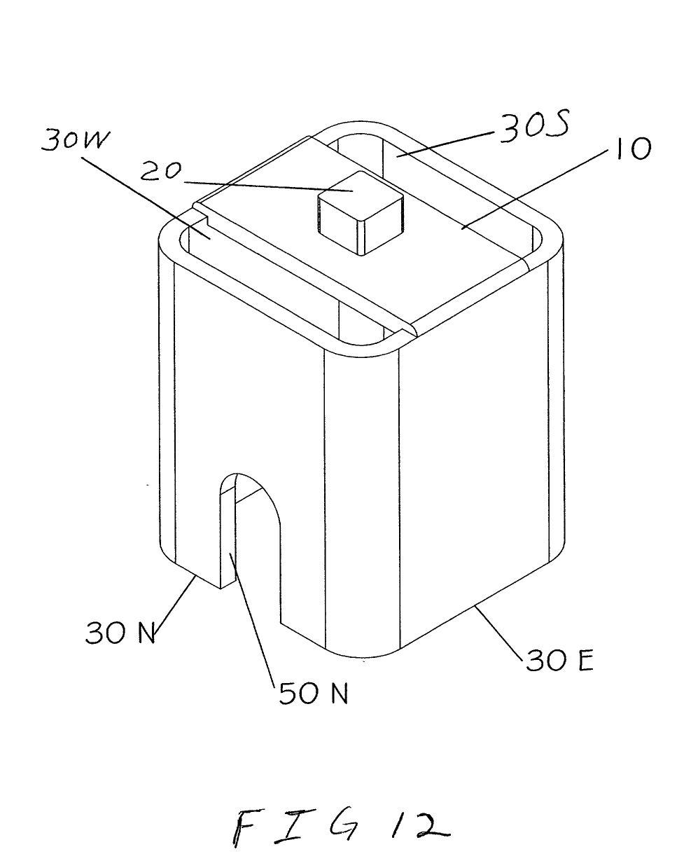

In the embodiment depicted in FIGS. 1 and 2, attachment means 20 is shown as a polygonal opening with which a rectangular drive of a socket wrench (also known as a ratchet wrench) couples. However attachment means 20 can be configured in other manners, as would be recognized by one skilled in the art, such as when it would be comprised of a post protruding from top connecting element 10 which could be configured to match the opening and size of a socket attached to a socket wrench; such a post is shown in FIG. 12.

There are various possibilities with regard to the relative placement of top connecting element 10. In the embodiment depicted in FIGS. 1 and 2, top connecting element 10 is fixedly attached to a sidewall 30N and to a sidewall 30S by welding and is placed so that a portion of top connecting element 10 lies completely between sidewall 30N and sidewall 30S and a portion of top connecting element 10 is situated above the top of sidewall 30N and the top of sidewall 30S. However, as would be recognized by one skilled in the art, top connecting element 10 can also be fixedly attached so that all top connecting element 10 lies completely between sidewall 30N and sidewall 30S or so that top connecting element 10 is fixedly attached atop 30N and sidewall 30S. In addition, top connecting element 10 can be fixedly attached in any number of ways, such as by a pin, a screw, glue, solder, electrofusing, fusing, computerized numerically controlled machining, machining, machine grooving, etc. or can even be unitary with sidewall 30N and sidewall 30S, as would be recognized by one skilled in the art, such as when the servicing socket is made from a mold or die cast.

In the preferred embodiment in FIGS. 1 and 2, top connecting element 10 is centered in the remaining two opposing sections of the sidewall and is typically 7.62 centimeters (3 inches) in length and 3.81 centimeters (1.5 inches) in width and 0.508 centimeters (0.2 inches) thick. However, as would be recognized by one skilled in the art, top connecting element 10 can also be formed in alternate configurations such as covering more or less of the width between sidewall 30E, and sidewall 30W, respectively and more or less thick; the only requirement is that top connecting element 10 prove the amount of stability between the wrench and the rest of the servicing socket to transfer the torque force to the connecting valve; typically this size depends upon the distance between sidewall 30E and sidewall 30W and between sidewall 30N and sidewall 30S. Generally speaking where the distance between sidewall 30E and sidewall 30W is 7.62 centimeters (3 inches), then the width ranges from 2.54 centimeters (1.0 inch) to 3.81 centimeters (1.5 inches) and the thickness ranges from 0.508 centimeters (0.2 inches) to 2.54 centimeters (1.0 inch).

In the embodiment depicted in FIGS. 1 and 2, the first encompassing means is embodied by a tube where sidewall 30N meets along its one edge with an edge of a sidewall 30E and along its other edge with an edge of a sidewall 30W; a remaining edge of sidewall 30W meets with an edge of sidewall 30S while a remaining edge of sidewall 30S completes the formation of a cavity 90 by meeting with the edge of sidewall 30E. Cavity 90 is a hollow into which the connecting valve is placed, thus allowing the second connecting apparatus-associated element to encompass the connecting valve.

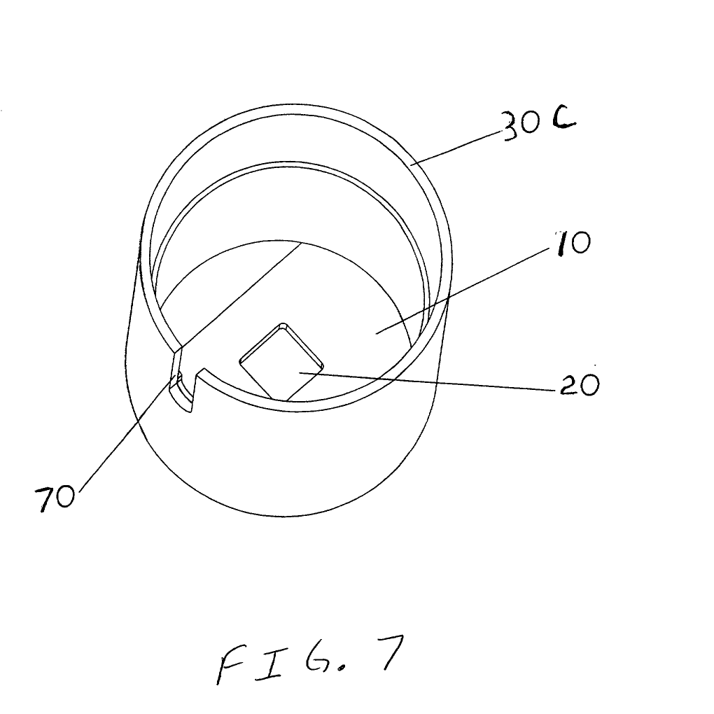

In FIGS. 1 and 2, the first encompassing means is achieved by cut square metal tubing; however sidewall 30N, sidewall 30E, sidewall 30S, and sidewall 30W could be manufactured in various ways as one skilled in the art would recognize such as by cutting and welding sheets of metal together or molding the same or forming the same from computerized numerically controlled machining. In an alternative embodiment depicted in FIGS. 7 through 10, in place of sidewall 30N, sidewall 30E, sidewall 30S, and sidewall 30W there is a cylindrical sidewall 30C; the cylindrical nature of sidewall 30C forms cavity 90. Sidewall 30C can be manufactured in any of the ways that sidewall 30N, sidewall 30E, sidewall 30S, and sidewall 30W are.

In the embodiment depicted in FIGS. 1 and 2, because the tubing is sized to fit the connecting valve, sidewall 30E and 30W are themselves the contact surface of the second connecting apparatus-associated element for transferring force applied to a wrench onto said connecting valve, thereby turning the connecting valve.

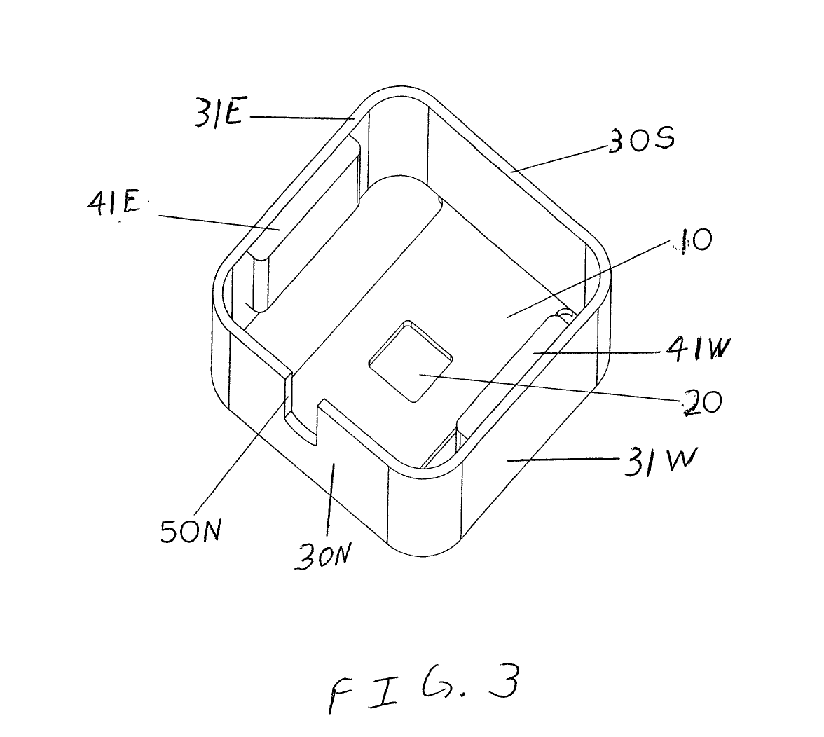

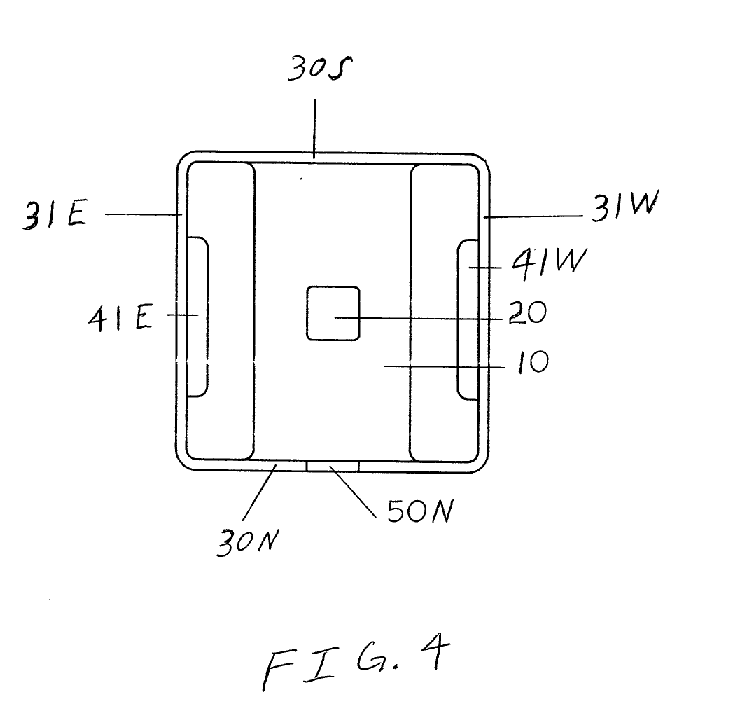

However, where the connecting valve is of a smaller size, then adjustment mechanisms such as a guideplate 41E and a guideplate 41W are attached to sidewalls 31E and 31W respectively, as depicted in FIGS. 3 (isometric view) and 4 (plan view) so that there is a contact surface for transferring force applied to a wrench onto said connecting valve, thereby turning the connecting valve. Although FIGS. 3 and 4 show guideplate 41E and guideplate 41W as fixedly attached to a sidewall 31E and a sidewall 31W respectively, they could be manufactured and attached in a number of ways as would be recognized by one skilled in the art, such as when the servicing socket is made from a mold or a die.

In the embodiment depicted in FIGS. 3 and 4 guideplate 41E is centered in the middle and at the bottom of the inside of sidewall 31E while guideplate 41W is centered in the middle and at the bottom of the inside of sidewall 31W. Both guideplate 41E and 41W are each typically 3.81 centimeters (1.5 inches) in length and 5.08 centimeters (2 inches) top to bottom, leaving 2.54 centimeters (1 inch) between the top of sidewall 31E and the top of guideplate 41E and between the top of sidewall 31W and the top of guideplate 41W. Optionally both guideplate 41E and guideplate 41W may be formed in alternate configurations such as covering more or less of the width and height of sidewall 31E, and sidewall 31W, respectively; the only requirement is that each guideplate 41E and 41W prove the amount of contact with the connecting valve necessary to transfer the torque force to the connecting valve; typically size this ranges from 1.27 centimeters (0.5 inch) in length and 1.27 centimeters (0.5 inch) from top to bottom to 7.62 centimeters (3.0 inches) in length and 7.62 centimeters (3.0 inches) from top to bottom.

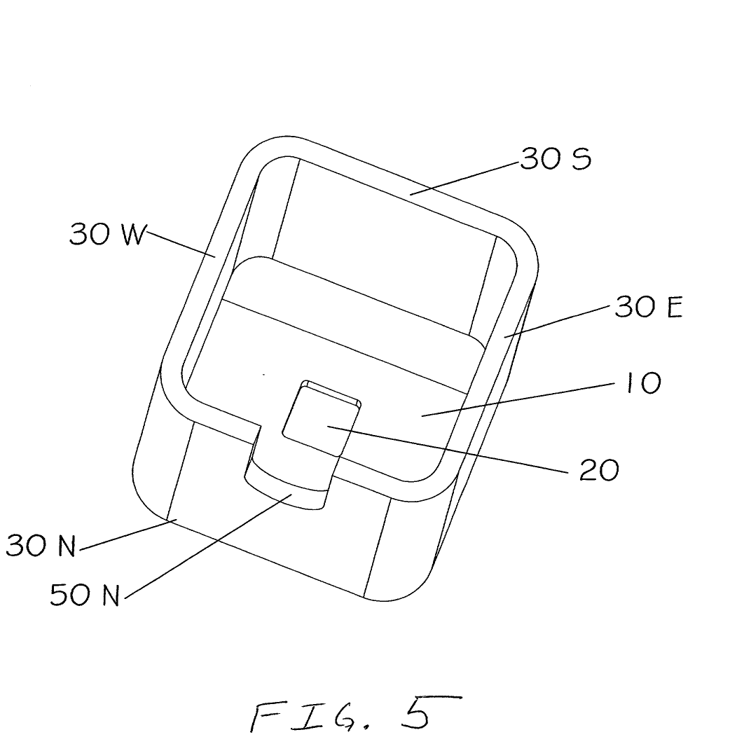

In the alternative embodiment depicted in FIGS. 5 (isometric view) and 6 (plan view) where the connecting valve is of a smaller size, then an adjustment mechanism such as connecting valve insert attachment 80 depicted in FIG. 13 is attached to the connecting valve, and then there will be a proper fit for the transfer of torque force from the tool to the connecting valve together when the connecting valve and connecting valve insert attachment 80 are placed into cavity 90. FIG. 14 shows connecting valve insert attachment 80 placed inside cavity 90 in a “square” embodiment of the invention.

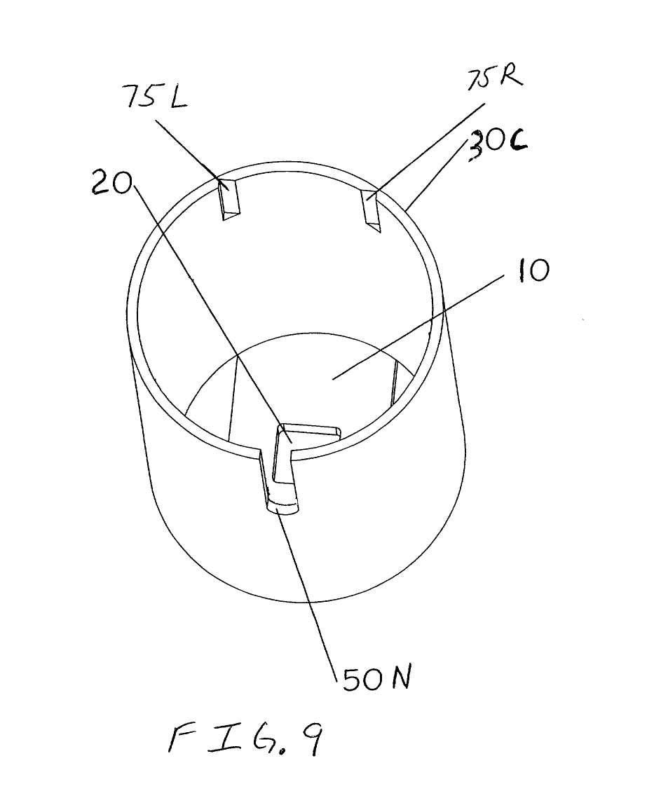

In the alternative embodiment depicted in FIGS. 7 through 9, the encompassing means for the second connecting apparatus-associated element takes the shape of circular tubing forming cylindrical sidewall 30C as depicted. In FIGS. 7 (isometric view) and 8 (plan view) cylindrical sidewall 30C is manufactured in the appropriate interior diameter sizes to connect directly with a generally round connecting valve, thus becoming the second connecting apparatus associated element. In FIG. 9 an alternative embodiment is depicted as in cylindrical sidewall 30C there has been a modification to both the left and right sides of cylindrical sidewall 30C: a left hand machined valve contact spot 75L and a right hand machined valve contact spot 75R respectively have been machined into cylindrical sidewall 30C to provide a contact places between the flat side of a connecting valve and cylindrical sidewall 30C.

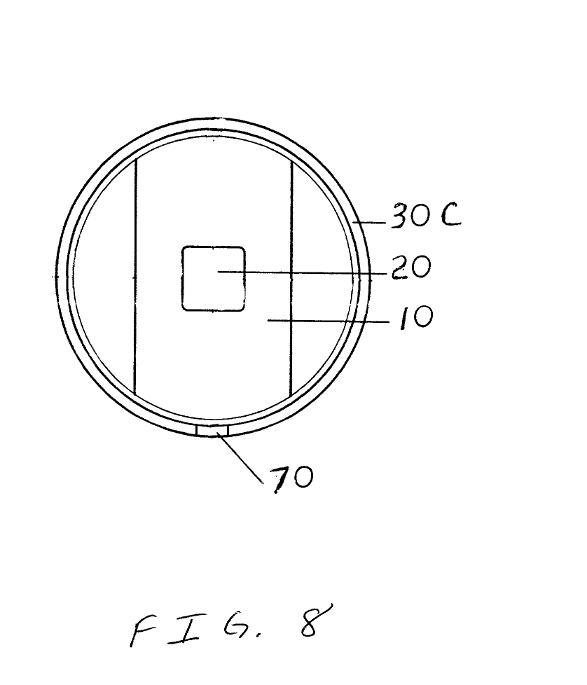

Additionally, in the alternative embodiments depicted in FIGS. 7 through 9, there is an aperture machined into cylindrical wall 30C: in FIGS. 7 and 8, it is a gripping slot 70 as it is sized to just allow the turn key into gripping slot 70 and provides a contact surface for the transferring of torque force applied to a wrench; in FIG. 9, it is the turn key indicator 50N and does not provide an additional contact surface for the transferring of torque force.

To ascertain the location of the connecting valve turn key, the depicted embodiment in FIGS. 1 and 2 shows a turn key location device 50N machined into sidewall 30N, that is, a slot through sidewall 30N; however turn key location device 50N could be produced in any number of ways as would be recognized by one skilled in the art, such as by punch die press or by mold insertion.

In the embodiment depicted in FIGS. 1 and 2 a slot 50S is machined into sidewall 30S to keep a not shown connecting valve packing nut from being placed wholly inside cavity 90; however slot 50S could be produced in any number of ways as would be recognized by one skilled in the art, such as such as by punch die press or by mold insertion. Optionally, slot 50S can be formed in alternate configurations such as a wider slot in sidewall 30S or a square slot in said sidewall 30S. The only requirement is that slot 50S be large enough to allow the corporation stop valve packing nut to remain to some extent outside cavity 90.

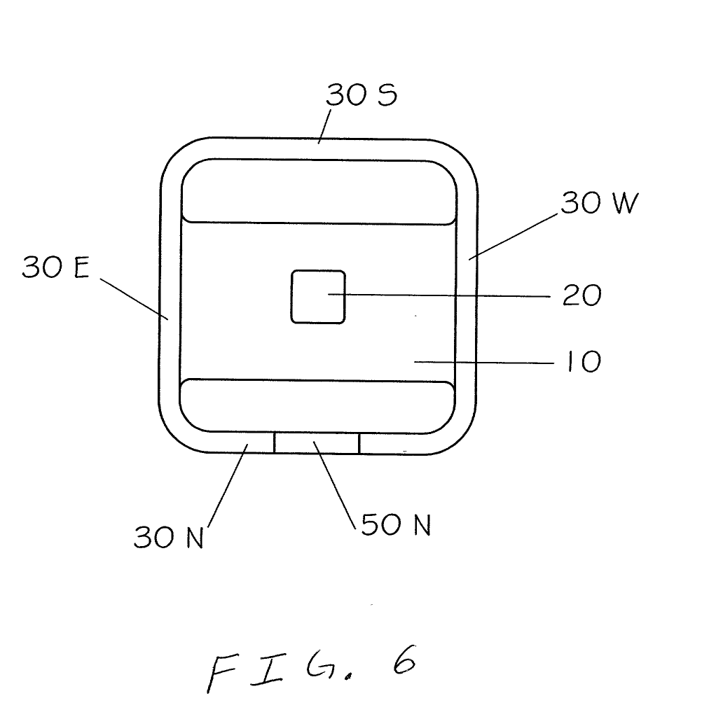

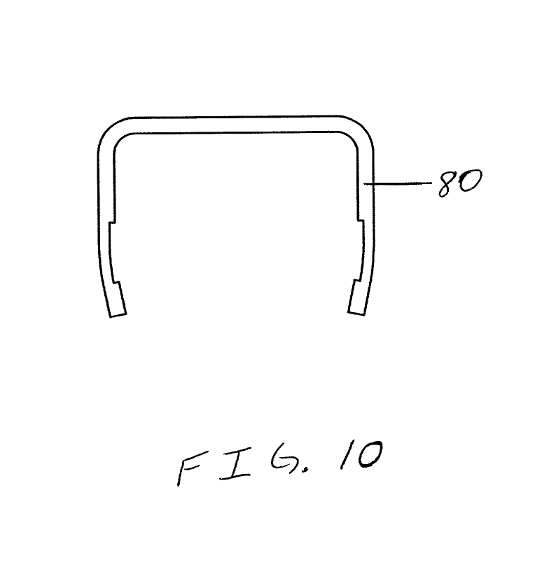

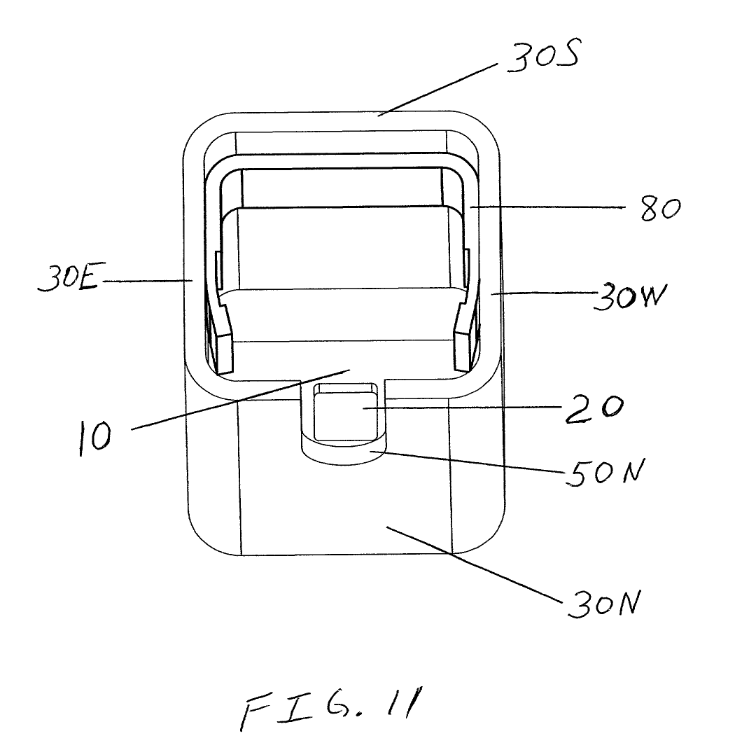

The embodiment depicted in FIGS. 5 and 6 is a “square” embodiment and with the use of a connecting valve insert attachment 80 can be used with a generally round connecting valve. FIG. 10 is a plan view of connecting valve insert attachment 80. FIG. 11 shows connecting valve insert attachment 80 inside of the “square” embodiment of the invention; no connecting valve is shown. Connecting valve insert attachment 80 is generally a size that just fits inside cavity 90 and is made of the same type of material as is top connecting element 10. Connecting valve insert attachment 80 is thick enough to enable direct simultaneous contact with the connecting valve and sidewall 30E and sidewall 30W when connecting valve insert attachment 80 and the connecting valve are both inside cavity 90. Connecting valve insert attachment 80 is designed to slip around the sides of connecting valves, and the design will vary to match the various connecting valves.

In the depicted embodiments in FIGS. 1 through 12, the servicing socket and each of its members is made from milled steel. However each member of the servicing socket could be made from a selection of alternative rigid material such as aluminum, engineering plastics, plastic with or without reinforcing, high density polyethylene and various composite materials that can remain rigid under the application of torque force energy, such as galvanized steel, black iron, ductile iron, black steel, carbon fiber, metal composites, metal alloys, etc. Further, alternate fabrication processes may be used such as forged steel, casting, molding, computerized numerically controlled machining, machining, fusing, electrofusing, etc., depending on the strength and weight requirements.

### DETAILED DESCRIPTION OPERATION

FIGS. 1 Through 4, and 7 through 9: Tightening/Installing

The servicing socket as embodied in FIGS. 1 through 4, and 7 through 9, in accordance with the present invention operates in the following manner. When a person desires to install a not shown connecting valve, that person starts the installation by beginning to thread the connecting valve into a not shown main pipe by hand thereby engaging the threads of the main pipe and of the connecting valve.

Utilizing the invention as embodied in FIGS. 1 and 2, the installer then places the connecting valve into cavity 90 so that the turn key of the connecting valve aligns with turn key location device 50N and the connecting valve packing nut slides into slot for connecting valve packing nut 50S. Utilizing the invention as embodied in FIGS. 3 and 4, the installer then places the connecting valve into cavity 90 so that the turn key of the connecting valve aligns with guideplate 41E and 41W. As embodied in FIGS. 7 and 8, the installer then places the connecting valve into cavity 90 so that the turn key slides into gripping slot 70. As embodied in FIG. 9, the installer also places the connecting valve so that the left hand side of the connecting valve is posited on the left hand machined valve contact spot 75L and the right hand machined valve contact spot 75R.

After the connecting valve is in cavity 90, the installer attaches to the servicing socket a not shown wrench through use of attachment means 20.

As embodied in FIGS. 1 and 2, after that attachment is made, the installer applies force to the wrench so that the overall engagement between contact surface of sidewall 30E and the connecting valve and the contact surface of sidewall 30W and the connecting valve transfers the torque force from the wrench to the connecting valve, thereby further threading the connecting valve correctly into the main pipe without damaging the connecting valve.

As embodied in FIGS. 3 and 4, after that attachment is made, the installer applies force to the wrench so that the overall engagement between guideplate 41E and the connecting valve and the contact surface of sidewall 41W and the connecting valve transfers the torque force from the wrench to the connecting valve, thereby further threading the connecting valve correctly into the main pipe without damaging the connecting valve.

In the alternative embodiments depicted in FIGS. 7 and 8, after that attachment is made, the installer then applies force to the wrench so that the overall engagement among gripping slot 70, cylindrical sidewall 30C, and the connecting valve transfers the torque force from the wrench to the connecting valve, thereby further threading the connecting valve correctly into the main pipe without damaging the connecting valve.

In the alternative embodiments depicted in FIG. 9, after that attachment is made, the installer then applies force to the wrench so that the overall engagement among left hand machined valve contact spot 75L, right hand machined valve contact spot 75R, and the connecting valve transfers the torque force from the wrench to the connecting valve, thereby further threading the connecting valve correctly into the main pipe without damaging the connecting valve.

FIGS. 1 Through 4, and 7 Through 9: Loosening/Removing

As embodied in FIGS. 1 and 2, when a person desires to remove or loosen a not shown connecting valve, that person places cavity 90 over the connecting valve so that the turn key of the connecting valve aligns with turn key location device 50N, and the connecting valve packing nut slides into slot for connecting valve packing nut 50S.

As embodied in FIGS. 3 and 4, when a person desires to remove or loosen a not shown connecting valve, that person places cavity 90 over the connecting valve so that the turn key of the connecting valve aligns with guideplate 41E and 41W.

As embodied in FIGS. 7 and 8, when a person desires to remove or loosen a not shown connecting valve, that person places cavity 90 over the connecting valve so that the turn key slides into gripping slot 70.

As embodied in FIG. 9, when a person desires to remove or loosen a not shown connecting valve, that person places cavity 90 over the connecting valve so that the left hand side of the connecting valve is posited on left hand machined valve contact spot 75L and right hand machined valve contact spot 75R.

After the placement of the connecting valve into cavity 90 and after the above mentioned alignments, the user then attaches a wrench through use of attachment means 20. After that attachment is made the user then applies force to the wrench so that the overall engagement between servicing socket and the connecting valve transfers the torque force from the wrench to the connecting valve, thereby unthreading the connecting valve from the main pipe without damaging the connecting valve.

FIGS. 5, 6, 10 and 11: Tightening/Installing

The operation of the servicing socket as embodied in FIGS. 5, 6, and 11, is as follows. When a person desires to install a not shown connecting valve, that person first starts the installation by beginning to thread the connecting valve into a not shown main pipe by hand thereby engaging the threads of the main pipe and of the connecting valve. After starting the threading, the installer then places connecting valve insert attachment 80 onto the body of the connecting valve and then places the connecting valve and connecting valve insert attachment 80 into cavity 90 so that the turn key of the connecting valve aligns with turn key location device 50N and further aligns connecting valve insert attachment 80 with sidewall 30E and sidewall 30W. After the connecting valve is in cavity 90 and aligned, the installer attaches a not shown wrench through use of attachment means 20.

After that attachment is made, the installer applies force to the wrench so that the overall engagement among sidewall 30E, sidewall 30W and the connecting valve insert attachment 80 transfers the torque force from the wrench to the connecting valve, thereby further threading the connecting valve correctly into the main pipe without damaging the connecting valve.

FIGS. 5, 6, 10 and 11: Loosening/Removing

As embodied in FIGS. 5, 6, and 11 when a person desires to remove or loosen a not shown connecting valve, that person first places connecting valve insert attachment 85 onto the body of the connecting valve and then places cavity 90 over the connecting valve and then attaches a wrench through use of attachment means 20. After that attachment is made the user then applies force to the wrench so that the overall engagement among sidewall 30E, sidewall 30W and connecting valve insert attachment 80 transfers the torque force from the wrench to the connecting valve, thereby unthreading the connecting valve from the main pipe without damaging the connecting valve.

Although only a few embodiments of the servicing socket for branch pipe connecting valves have been described in detail above, all improvements and modifications to the servicing socket within the scope of the claims are covered by said servicing socket. Reasonable modifications and alterations of this invention will become apparent to those skilled in the art from the foregoing discussion and accompanying drawings, and it should be understood that this invention is not to be unduly limited thereto.

### CONCLUSION RAMIFICATIONS AND SCOPE

From the above, the reader will see that the servicing socket of the invention provides an easy means to turn branch pipe connecting valves without damaging the body of the connecting valve and can be used in confined quarters.

Although the description above contains many specificities, these should not be construed as limiting the scope of the invention but as merely providing illustrations of some of the present embodiments of the invention. For example: the servicing socket can have other shapes, such as oval, rounded corners, trapezoidal, etc.; attachment means 20 can also be configured to be a squared extension with a length ranging from 1.27centimeters (0.5 inch) to 0.601 meters (2 feet) around which a pipe wrench could easily attach; each guideplate 40E and 40W could be simply individual inserts rather than being fixedly attached to a sidewall. As a further example, turn key location device 50N can be located in other spots on the servicing socket and can be formed in alternate configurations such as a metal strip on the exterior of a sidewall, or as some indicator on the exterior of a sidewall, such as an embossed line, arrow, a painted line, an indentation, a square slot, the only requirement is that turn key location device 50N be visible to the person using the servicing socket and accurately convey to the user the location of the connecting valve turn key in relation to a main pipe.

Further it will be understood that each of the elements described in this disclosure specification, or two or more together, may also find a useful application in other types of constructions differing from the types described above. While the invention has been illustrated and described as embodied in tool servicing socket, it is not intended to be limited to the details shown, since various modifications and structural changes may be made without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Hence the scope of the servicing socket for branch pipe connecting valves should be determined by the appended claims and their legal equivalents, rather than by the examples given

I claim:

1. A tool socket comprising:
a) a first tool-associated socket element provided with a first connection means formed to connect said first tool-associated element directly with a tool in order to be turned by said tool;
b) a second connecting apparatus-associated element provided with a first encompassing means for enveloping a central body of a fluid distribution connecting apparatus joining a customer service branch pipe to another distribution pipe of a fluid distribution system wherein the tightening and loosening of said fluid distribution connecting apparatus is facilitated;
c) said second connecting apparatus-associated element provided with a third connecting means for connecting said first tool-associated socket element with said second connecting apparatus-associated element;
whereby force urged upon said tool turns both said first tool-associated socket element and said second connecting apparatus-associated element in turn effecting the turning of the fluid distribution connecting apparatus while said second connecting apparatus-associated element is also protecting said fluid distribution connecting apparatus during the turning and also facilitating the turning of said fluid distribution connecting apparatus even in confined quarters.

2. The tool socket of claim 1, wherein said first connection means for connecting is selected from the group consisting of polygonal voids in said first tool-associated element and post extensions extending from said first tool-associated element.

3. The tool socket of claim 1, wherein said second connecting apparatus-associated element is comprised of a tubing.

4. The tool socket of claim 3, wherein said second connecting means further includes an insert attachment formed on the interior side of said insert attachment to attach to said fluid distribution connecting apparatus and formed on the exterior side of said insert attachment to provide a contact surface with said second connecting apparatus-associated element and of a size to fit within said second connecting apparatus-associated element and transferring to the apparatus torque force applied to said tool.

5. The tool socket of claim 3, wherein said second connecting means further includes guideplates on interior side of second connecting means providing a raised contact surface on said second connecting apparatus-associated element contacting said fluid distribution connecting apparatus and transferring to the apparatus torque force applied to said tool.

6. The tool socket of claim 3, wherein said second connecting means further includes a first transfer element selected from the group consisting of:
a gripping slot through said second connecting means only wide enough to allow said turn key to be placed into said slot for the duration of time that said fluid distribution connection apparatus is in said cavity in order to transfer to the apparatus of torque force applied to said tool, and
carveouts machined out of the interior of said second connecting apparatus-associated element creating a contact surface between said second connecting apparatus-associated element and the apparatus and allowing the transfer to the apparatus of torque force applied to said tool.

7. The tool socket of claim 1, wherein said second connecting apparatus-associated element is comprised of sheets of material joined together at the edges so as to form a cavity.

8. The tool socket of claim 7, wherein said second connecting means further includes an insert attachment formed on interior side of said insert attachment to attach to said fluid distribution connecting apparatus and formed on the exterior side of said insert attachment to provide a contact surface with said second connecting apparatus-associated element.

9. The tool socket of claim 7, wherein said second connecting means further includes guideplates on interior side of second connecting means providing a raised contact surface on said second connecting apparatus-associated element contacting said fluid distribution connecting apparatus and transferring to the apparatus torque force applied to said tool.

10. The tool socket of claim 7, wherein said second connecting means further includes a first transfer element selected from the group consisting of
a gripping slot through said second connecting means only wide enough to allow said turn key to be placed into said slot for the duration of time that said fluid distribution connection apparatus is in said cavity in order to transfer to the apparatus of torque force applied to said tool, and
carveouts machined out of the interior of said second connecting apparatus-associated element creating a contact surface between said second connecting apparatus-associated element and the apparatus and allowing the transfer to the apparatus of torque force applied to said tool.

11. The tool socket of claim 1, further including a means for ascertaining the location of a turn key of said fluid distribution connecting apparatus as the apparatus is tightened and loosened.

12. The tool socket of claim 11, wherein said means for ascertaining the location of said turn key comprises a slot through said second connecting apparatus-associated element.

13. The tool socket of claim 1, further including a means for allowing a corporation stop valve packing nut to be disposed partially outside the interior side of said second connecting apparatus-associated element.

14. The tool socket of claim 15, wherein said means for allowing comprises a slot through said second connecting apparatus-associated element.

15. A tool socket comprising:
a) a first tool-associated socket element provided with a first connection element selected from the group consisting of polygonal voids and post extensions formed to connect said first tool-associated element directly with a tool in order to be turned by said tool;
b) a second connecting apparatus-associated element formed to envelope a main body of a fluid distribution connecting apparatus joining a customer service branch pipe to another distribution pipe of a fluid distribution system wherein the tightening and loosening of the apparatus is facilitated;
c) said second connecting apparatus-associated element containing an adjustment mechanism selected from the group consisting of:
an insert attachment having an interior side for attaching to said fluid distribution connecting apparatus and having an exterior side for providing a contact surface with said second connecting apparatus-associated element and having a size to fit within said second connecting apparatus-associated element and transferring to the apparatus torque force applied to said tool, and
guideplates on interior side of said second connecting apparatus-associated element providing a raised contact surface on said second connecting apparatus-associated element for contacting said fluid distribution connecting apparatus and transferring to the apparatus torque force applied to said tool;
d) said second connecting apparatus-associated element attached to said first tool-associated socket element by a manner selected from the group consisting of computerized numerically controlled machining, machining, fusing, electrofusing, welding, solder, glue, pins, machined grooving, and male/female devices on the second connecting element and on the first socket element.
whereby force urged upon said tool turns both said first tool-associated socket element and said second connecting apparatus-associated element in turn effecting the turning of the fluid distribution connecting apparatus while said second connecting apparatus-associated element is also protecting said fluid distribution connecting apparatus during the turning and also facilitating the turning of said fluid distribution connecting apparatus even in confined quarters.

16. A method for connecting a fluid distribution connecting apparatus to another distribution pipe of a fluid distribution system, said method comprising:
a) providing a first tool-associated socket element with a first connection means formed to connect said first tool-associated element directly with a tool in order to be turned by the tool;
b) providing a second connecting apparatus-associated element having a first encompassing means for enveloping a central body of said fluid distribution connecting apparatus wherein the tightening and loosening of said fluid distribution connecting apparatus is facilitated;
c) providing said second connecting apparatus-associated element with a third connecting means for connecting said first tool-associated socket element with said second connecting apparatus-associated element; and
d) urging torque force upon said tool wherein both said first tool-associated socket element and said second connecting apparatus-associated element are turned and in turn effecting the turning of said fluid distribution connecting apparatus while said second connecting apparatus-associated element is also protecting said fluid distribution connecting apparatus during the turning and also facilitating the turning of said fluid distribution connecting apparatus even in confined quarters.

17. A method in accordance with claim 16, said method additionally comprising:
providing said second connecting apparatus-associated element with an adjustment mechanism selected from the group consisting of:
an insert attachment having an interior side for attaching to said fluid distribution connecting apparatus and having an exterior side for providing a contact surface with said second connecting apparatus-associated element and having a size to fit within said second connecting apparatus-associated element and transferring to the apparatus torque force applied to said tool, and
guideplates on interior side of said second connecting apparatus-associated element providing a raised contact surface on said second connecting apparatus-associated element for contacting said fluid distribution connecting apparatus and transferring to the apparatus torque force applied to said tool;

18. The tool socket of claim 1, further including:
a) a first tool-associated socket element provided with a first connection element selected from the group consisting of polygonal voids and post extensions formed to connect said first tool-associated element directly with a tool in order to be turned by said tool;
b) a second connecting apparatus-associated element formed to envelope a main body of a fluid distribution connecting apparatus joining a customer service branch pipe to another distribution pipe of a fluid distribution system wherein the tightening and loosening of the apparatus is facilitated;
c) said second connecting apparatus-associated element containing an adjustment mechanism selected from the group consisting of:
an insert attachment having an interior side for attaching to said fluid distribution connecting apparatus and having an exterior side for providing a contact surface with said second connecting apparatus-associated element and having a size to fit within said second connecting apparatus-associated element and transferring to the apparatus torque force applied to said tool, and
guideplates on interior side of said second connecting apparatus-associated element providing a raised contact surface on said second connecting apparatus-associated element for contacting said fluid distribution connecting apparatus and transferring to the apparatus torque force applied to said tool;
d) said second connecting apparatus-associated element attached to said first tool-associated socket element by a manner selected from the group consisting of computerized numerically controlled machining, machining, fusing, electrofusing, welding, solder, glue, pins, machined grooving, and male/female devices on the second connecting element and on the first socket element.
